(19) United States
(12) Patent Application Publication
(10) Pub. No.: US 2023/0125491 A1
(43) Pub. Date: Apr. 27, 2023

(54) WORKLOAD MIGRATION

(71) Applicant: INTERNATIONAL BUSINESS MACHINES CORPORATION, Armonk, NY (US)

(72) Inventors: Douglas Gordon Kinnaird, Calgary (CA); Clea Zolotow, Key West, FL (US); Mansura Habiba, Jhonstown (IE); Hasibe Göçülü, Selcuklu (TR); Neil Toussaint, Malvern (GB); Ana Maria Bezerra Maimoni, Sao Paulo (BR)

(21) Appl. No.: 17/509,680

(22) Filed: Oct. 25, 2021

(51) Int. Cl. G06F 9/50; G06K 9/62; G06N 20/00

(52) U.S. Cl. CPC G06F 9/5088; G06K 9/6257; G06K 9/6263; G06N 20/00

(57) ABSTRACT

Embodiments of the present invention provide concepts for identifying an edge computing environment location as a target for workload migration. For example, embodiments may provide for a machine-learning algorithm to be trained to predict or suggest the most appropriate edge location for migrating a workload. Using a description of a workload, the machine-learning algorithm may predict/suggest one or more edge locations.

### BACKGROUND

The technical character of the present disclosure generally relates to the field of Information Technology (IT) systems, and more particularly, systems and methods for workload migration in IT systems.

In the field of IT, workload migration describes moving one or more IT systems with all associated infrastructure and applications from one operating environment to another. Typically, a workload migration program is driven by an external compelling event such as data center closure. The execution of a workload migration program is usually a complex problem due to many factors, including: the large number of components and the relationships between all the Configuration Items (CIs); the time required for workload migration often means that business changes must be accommodated (which may impact CI relationships and dependencies); the involvement of multiple data centers; and the disruptive nature of workload migration.

The typical solution to discovery of the CIs and their relationships is to place agents on endpoint devices or run agentless scans from centralized systems and gather information about installed components and inspect network flows to determine relationships. This raw data is then sent back to centralized systems for analysis and to support workload migration planning activities. The scans are repeated to ensure changes to the IT environment are captured. Such a known solution is resource intensive and time-consuming, and thus improved approaches to workload disruption are desired.

### SUMMARY

Aspects of the present invention provide a method of training a machine learning algorithm for identifying an edge computing environment location as a target for workload migration. Aspects of the present invention also provide a method for workload migration at an edge computing environment. Such methods may be computer-implemented. That is, such methods may be implemented in a computer infrastructure having computer executable code tangibly embodied on a computer readable storage medium having programming instructions configured to perform a proposed method. Aspects of the present invention further provide a computer program product including computer program code for implementing the proposed concepts when executed on a processor. Aspects of the present invention yet further provide a system for training a machine learning algorithm for identifying an edge computing environment location as a target for workload migration. Aspects of the present invention also provide a system for workload migration at an edge computing environment.

According to an aspect of the present invention, there is a method of training a machine learning algorithm for identifying an edge computing environment location as a target for workload migration. The method comprises receiving: i) a description of a training workload; and ii) an identifier of an edge location for migrating the training workload. The method also comprises training the machine learning algorithm based on the description of a training workload as a training input for the machine learning algorithm and the identifier of the edge location for migrating the training workload as a training output for the machine learning algorithm.

Implementations of the invention may utilize edge computing. Such implementations may leverage reduced processing and power costs of edge locations which can be positioned: close to the systems to be migrated; on the network(s); and/or embedded with the workloads to be migrated. Embodiments may thus make us of edge locations that are better positioned to detect and react to changes. Also, discovery and analytics may be distributed across multiple edge locations.

Embodiments may thus provide concepts for workload migration execution that may facilitate: reduced costs; higher quality; and/or reduced disruption.

In particular, embodiments may propose to use edge locations as sources for migrating workload between data centers.

In embodiments, to identify the latest (i.e., most up-to-date version) of workloads, suitable times for migration, and/or an aggregated group of dependent workloads, implementations of the invention use machine learning algorithms (e.g., deep learning models) that may be deployed in respective edge locations. Usage of distributed learning may make embodiments efficient, scalable and/or optimal. For instance, learning from different edge locations may further contribute to a more efficient centralized knowledge storage (where learning can be stored in the form of metadata for example), based on summary and analysis of raw data captured at numerous edge locations. Such learning and knowledge may improve a proposed workload migration model.

By way of example, the training may comprise adjusting a configuration of the machine learning algorithm so as to decrease an outage time objective. The proposed training concept(s) may thus be tailored to specific requirements or targets.

In some embodiments, the training may comprise adjusting a configuration of the machine learning algorithm so as to decrease a difference between the identifier of the edge location for migrating the training workload and a second identifier that is output by the machine learning component. That is, the machine learning algorithm may be trained towards outputting a known output for a known input, thus making use of known/training knowledge to improve prediction/output accuracy. The machine learning algorithm may thus be trained using a corpus of training workloads and identifiers of edge locations for migrating the training workloads.

The machine learning algorithm may, for example, comprise a neural network wherein the training is based on a loss function for the gradient of the neural network.

In some embodiments, the description of the training workload comprises a time series of a plurality of variables.

According to another aspect of the present invention, there is a method for workload migration at an edge computing environment. The method comprises providing a description of a workload to a machine learning algorithm for identifying an edge computing environment location as a target for workload migration. The method also comprises obtaining a prediction result from the machine learning algorithm based on the description of the workload, the prediction result including an identifier of an edge location.

In some implementations, a machine learning algorithm is trained using a training algorithm configured to receive an array of training inputs and known outputs, wherein the training inputs comprise descriptions of training workloads and the known outputs comprise identifiers of edge locations for migrating the training workloads.

Some embodiments may be configured to communicate the workload to an edge computing environment associated with the identifier of an edge location included in the prediction result.

Embodiments may be employed in combination with conventional/existing workload management systems and/or workload migration systems. In this way, embodiments may integrate into legacy systems so as to improve and/or extend their functionality and capabilities. An improved workload management/migration system may therefore be provided by proposed embodiments.

According to another embodiment of the present invention, there is a computer program product for training a machine learning algorithm for identifying an edge computing environment location as a target for workload migration, the computer program product comprising a computer readable storage medium having program instructions embodied therewith, the program instructions executable by a processing unit to cause the processing unit to perform a method according to one or more proposed embodiments when executed on at least one processor of a data processing system.

According to another embodiment of the present invention, there is a computer program product for workload migration at an edge computing environment, the computer program product comprising a computer readable storage medium having program instructions embodied therewith, the program instructions executable by a processing unit to cause the processing unit to perform a method according to one or more proposed embodiments when executed on at least one processor of a data processing system.

According to yet another aspect, there is a processing system comprising at least one processor and the computer program product according to one or more embodiments, wherein the at least one processor is adapted to execute the computer program code of said computer program product.

According to another aspect, there is a system for training a machine learning algorithm for identifying an edge computing environment location as a target for workload migration. The system comprises a processor arrangement configured to perform the steps of: receiving: i) a description of a training workload; and ii) an identifier of an edge location for migrating the training workload; and training the machine learning algorithm based on the description of a training workload as a training input for the machine learning algorithm and the identifier of the edge location for migrating the training workload as a training output for the machine learning algorithm.

According to yet another aspect, there is a system for workload migration at an edge computing environment. The system comprises a processor arrangement configured to perform the steps of: providing a description of a workload to a machine learning algorithm for identifying an edge computing environment location as a target for workload migration; and obtaining a prediction result from the machine learning algorithm based on the description of the workload, the prediction result including an identifier of an edge location.

In this manner, implementations of the invention provide machine learning approaches for identifying one or more edge locations as the source(s) for each workload wave during migration, disaster recovery, or redundancy from one compute facility (whether temporary, mobile, closet, or datacenter) to another. For instance, embodiments may provide for a machine-learning algorithm to be trained to nominate or suggest the most appropriate edge location(s) for migration of a workload. Using a description of a workload, the machine-learning algorithm may identify/suggest one or more edge locations for migrating the workload.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to embodiments of the present invention.

FIG. 3 depicts abstraction model layers according to embodiments of the present invention.

FIG. 4 depicts a cloud computing note according to another embodiment of the present invention.

FIG. 5 depicts simplified diagrams of training a machine learning algorithm for identifying an edge location according to an embodiment.

FIG. 6 depicts how the machine learning algorithm trained in FIG. 5 may be used for workload migration according to an embodiment.

FIG. 7 is an illustration depicting migration from one datacenter to another with edge locations according to an embodiment.

### DETAILED DESCRIPTION

It should be understood that the Figures are merely schematic and are not drawn to scale. It should also be understood that the same reference numerals are used throughout the Figures to indicate the same or similar parts.

In the context of the present disclosure, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present disclosure, a (processing) system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

Also, in the context of the present disclosure, a system may be a single device or a collection of distributed devices that are adapted to execute one or more embodiments of the methods of the present invention. For instance, a system may be a personal computer (PC), a portable computing device (such as a tablet computer, laptop, smartphone, etc.), a set-top box, a server or a collection of PCs, IoT sensors and/or servers connected via a network such as a local area network, 5G networking (i.e., mobile device networking), the Internet and so on to cooperatively execute at least one embodiment of the methods of the present invention.

The technical character of the present disclosure generally relates to workload management, and more particularly, to workload migration that may, for example, identify edge computing environments (i.e., edge locations) for migrating one or more workloads. More specifically, embodiments of the present invention provide concepts for automatically identifying an edge computing environment location as a target for workload migration, and such identification may employ machine learning techniques to analyze workload information (and suggest/predict one or more edge computing environments (i.e., edge locations) for migrating the workload.

Edge computing is a distributed computing paradigm which brings computation and data storage closer to the location it is needed, to improve response times and save bandwidth. In this paradigm, the smaller infrastructure components are distributed at the edge of the network. This facilitates the operation of end devices by acting as the relay to meet the needs of high-speed Internet of Things devices, thus reducing the bandwidth load of the network core. The same paradigm can be applied to cloud computing when it comes to connected devices. In such an arrangement, the first connection (i.e., hop) from smart devices, mobile phones, connected cars, drones, robots, etc. is not to large public clouds, but is instead to something closer, the Edge Cloud operating at the edge of the network. Unlike conventional workload migration approaches, embodiments may propose concepts for intelligently determining which edge computing resources (i.e., edge locations) to migrate one or more workloads to.

Embodiments may also be able to adapt to feedback and/or changing resources for future instances/occurrences of the same workload(s).

Embodiments may therefore obviate or mitigate problems associated with conventional workload migration approaches, by providing a method, a system and a computer program product for workload migration at an edge computing environment using machine learning algorithms. Also, concepts for training the machine-learning algorithms are provided.

Implementations may achieve such benefits through the use of machine-learning training approaches employing a corpus of training workloads and edge locations for migrating the training workloads. In some embodiments, for example, training may comprise adjusting a configuration of the machine learning algorithm so as to decrease a difference between the identifier of the edge location for migrating the training workload and a second identifier that is output by the machine learning component.

By way of further example, training may comprise adjusting a configuration of the machine learning algorithm so as to decrease an outage time objective.

After training, the machine learning algorithm may be expected to be able to receive a description of a workload (e.g., a time series of a plurality of variables) and provide a prediction/suggestion of an edge location most suited for migrating the workload.

It is understood in advance that although this disclosure includes a detailed description on cloud computing, implementation of the techniques recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service’s provider.
Broad network access: capabilities are available over a network and accessed through standard mechanisms that promote use by heterogeneous thin or thick client platforms (e.g., mobile phones, laptops, and PDAs).
Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

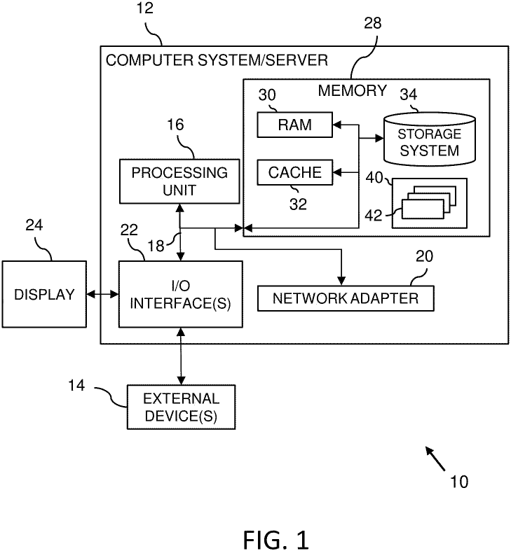

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment.

Program modules 42 generally carry out the functions and/or methodologies of embodiments of the invention as described herein. For example, some or all of the functions of a DHCP client 80 can be implemented as one or more of the program modules 42. Additionally, the DHCP client 80 may be implemented as separate dedicated processors or a single or several processors to provide the functionality described herein. In embodiments, the DHCP client 80 performs one or more of the processes described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID (redundant array of inexpensive disks or redundant array of independent disks) systems, tape drives, and data archival storage systems, etc.

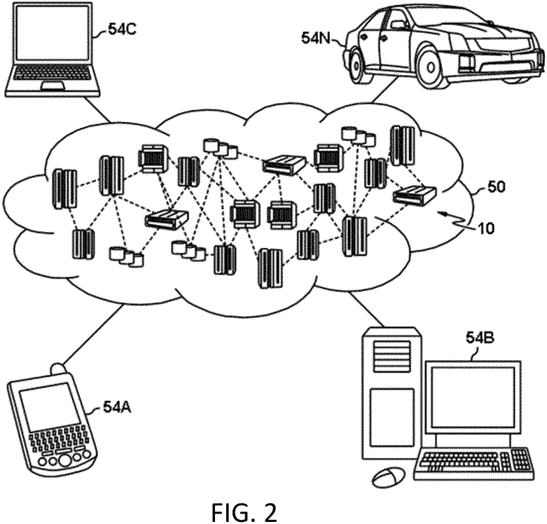

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

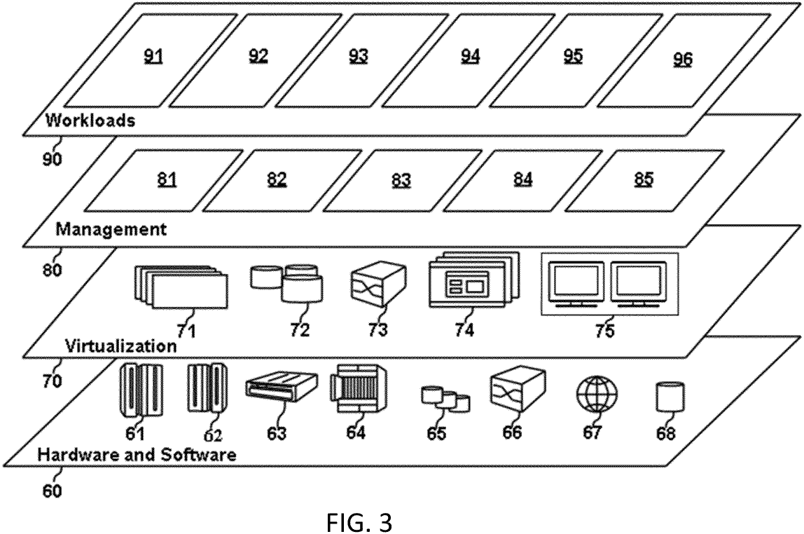

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture based servers 62; servers 63; blade servers 64; storage device 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workload management/migration processes 96 described herein. In accordance with aspects of the invention, the workload management/migration processes 96 function operates to perform one or more of the processes described herein.

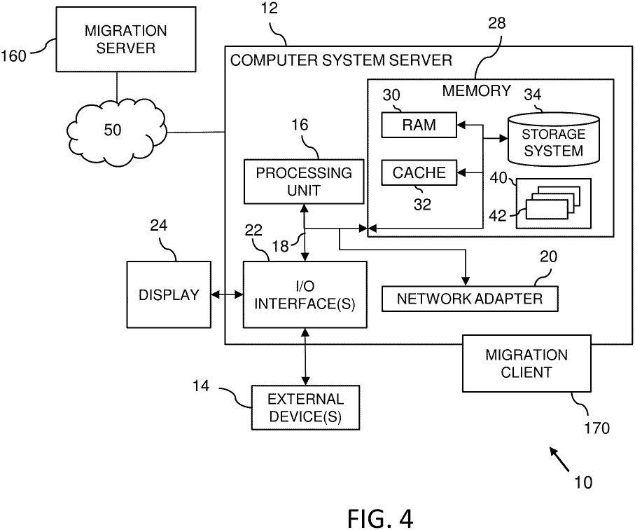

FIG. 4 depicts a cloud computing node according to another embodiment of the present invention. In particular, FIG. 4 is another cloud computing node which comprises a same cloud computing node 10 as FIG. 1. In FIG. 4, the computer system/server 12 also comprises or communicates with a migration client 170, and a migration server 160.

In accordance with aspects of the invention, the migration client 170 can be implemented as one or more program code in program modules 42 stored in memory as separate or combined modules. Additionally, the migration client 170 may be implemented as separate dedicated processors or a single or several processors to provide the function of these tools. While executing the computer program code, the processing unit 16 can read and/or write data to/from memory, storage system, and/or I/O interface 22. In embodiments, the program code executes the processes of the invention.

By way of example, migration client 170 may be configured to communicate with the migration server 160 via a cloud computing environment 50. As discussed with reference to FIG. 2, for example, cloud computing environment 50 may be the Internet, a local area network, a wide area network, and/or a wireless network. In embodiments, the migration server 160 may provision data to the migration client 170. One of ordinary skill in the art would understand that the migration client 170 and migration server 160 may communicate directly. Alternatively, a relay agent may be used as an intermediary to relay messages between migration client 170 and migration server 160 via the cloud computing environment 50.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

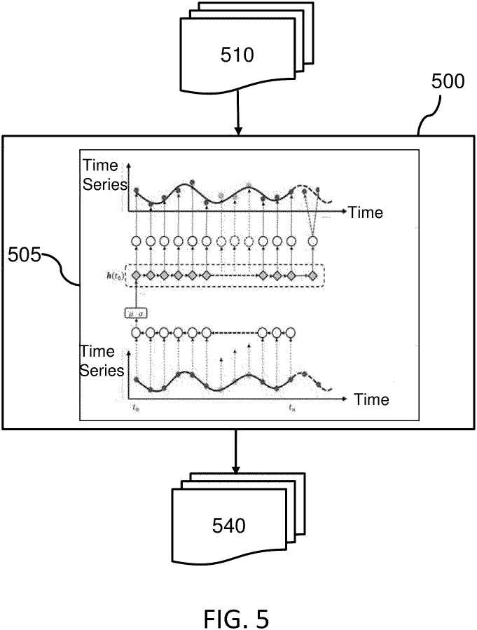

FIG. 5 illustrates an example of training a machine learning algorithm for identifying an edge computing environment location as a target for workload migration according to an embodiment. The example embodiment of FIG. 5 may be implemented in the environment of FIGS. 1 and 4, for example. As noted above, the flowchart(s) illustrate the architecture, functionality, and operation of possible implementations of systems, methods, and computer program products as already described herein in accordance with the various embodiments of the present invention.

Referring to FIG. 5, there is depicted a simplified diagram of training a machine learning algorithm according to an embodiment. Here, the machine-learning algorithm employs neural Ordinary Differential Equations (ODEs) 500.

Neural ODEs are a family of deep neural network models. Instead of specifying a discrete sequence of hidden layers, embodiments parameterize the derivative of the hidden state using a neural network. The output of the network is computed using a differential equation solver. Neural ODEs allow end-to-end training within larger models.

Other types of neural network, such as convolutional neural networks (CNNs) and recurrent neural networks (RNNs) are widely known.

Various approaches to training a machine-learning algorithm are known. Typically, such methods comprise obtaining a training dataset, comprising training input data entries 510 and corresponding training output data entries 540. An initialized machine-learning algorithm is applied to each input data entry 510 to generate predicted output data entries. An error between the predicted output data entries and corresponding training output data entries is used to modify the machine-learning algorithm. This process can be repeated until the error converges, and the predicted output data entries are sufficiently similar (e.g., ±1%) to the training output data entries. This is commonly known as a supervised learning technique.

Known methods of modifying a neural network include gradient descent, backpropagation algorithms and so on.

In embodiments, the training input data entries for the machine learning algorithm correspond to descriptions of training workloads. By way of example, a description of a workload may comprise, wherein the workload data is converted as time series of multiple variables:
V = {A set of VMs to migrate}
A = {A set of applications to migrate}
D = {A set of dependencies to migrate}
T= {A set of metadata for different application, peak hour and others}
Z= input which is a time series of multiple workload
Z= {V, A, D, T}

In embodiments, the training output data entries for the machine learning algorithm correspond to edge locations for migrating the training workload.

In accordance with aspects of the invention, several pre-processing methods are employed to improve the training sample(s). For instance, the data sources to be used as a dataset to train the proposed machine learning algorithm may have differentiating formats. Therefore, some pre-processing may be executed to bring all training data to a common format. For this, a data pre-processor component may be used, and all data that is used to train the machine learning algorithm model may be passed through the pre-processor to achieve a consistent format of the training data.

In embodiments, the data format is designed to preserve the relationship(s) between: (i) a workload (or a set of workloads); and (ii) an edge location for migrating the workload(s). In a simple form, the data may be represented as tuples of a workload and an identifier - (workload1, edgelocationA), ([workload2, workload3], edgelocationB), etc.

In implementations, the training data comes from an initial data set (e.g., training data), or from data incoming from a workload management deployment at an edge computing environment. The initial data set may be split into a training and test data set, to provide validation for the training process.

From the above description, it will be understood that embodiments include training a machine learning algorithm based on a description of a workload (as a training input for the machine learning algorithm) and the identifier of an edge location (i.e., edge resource) as a source for migrating the workload (as a training output for the machine learning algorithm). In one example, the training comprises adjusting a configuration of the machine learning algorithm so as to decrease a difference between the identifier of the edge location for migrating the workload and a second identifier that is output by the machine learning component.

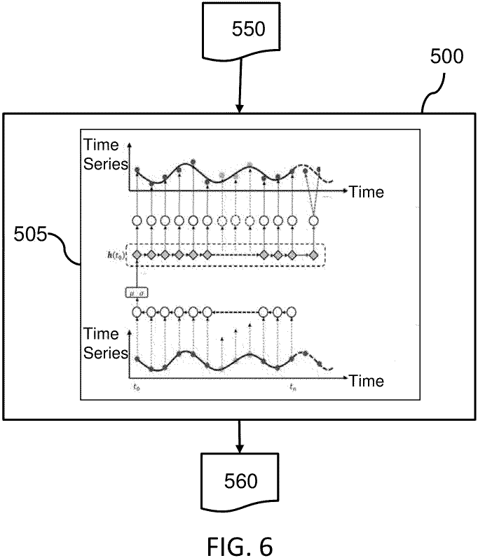

FIG. 6 is a simplified illustration depicting how the machine learning algorithm trained in FIG. 5 may be used for workload migration according to a proposed embodiment.

In embodiments, when a new workload is identified/obtained, a description 550 of the new workload (e.g., Z1= {V={V+V1}, A, D, T}) may be provided as an input to the artificial neural network 500. In the description of the new workload, any one of the parameter set may have a different value. A prediction result 560 may then be obtained as an output from the artificial neural network 500, wherein the prediction result 560 includes an identifier of an edge computing environment location as a target for workload migration. The identifier may then be distributed to the appropriate edge computing environment.

Embodiments include using a machine learning during a workload migration planning phase, wherein an edge layer analyzes the workloads running within the edge and “self-nominate” workloads to be migrated between edge nodes. In this manner, the workload planning machine learning models may be deployed within the edge computing environment (i.e., edge layer), because sufficient computational resources exist within the edge layer. This may help to eliminate unnecessary network traffic between the cloud and edge layers.

By way of illustration, an unmanned vehicle is an example of a “dynamic edge” application, where the number of workloads in the edge layer vary depending on the number of vehicles and their position. In this example, the machine learning model continuously optimizes the edge layer computational resources. The edge layer application software components are deployed in containers rather than VMs because containers have quicker initialization and are moved between clusters more quickly than VMs.

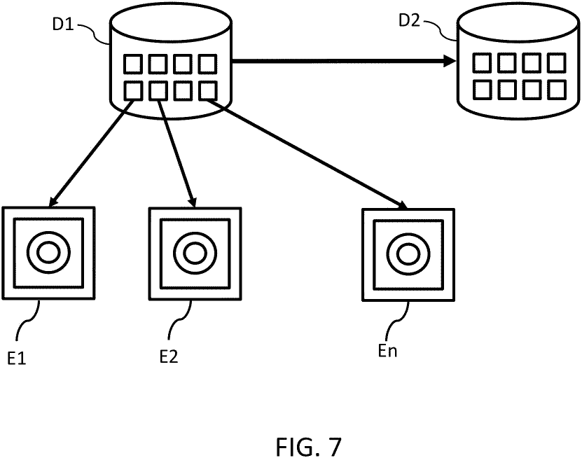

By way of further illustration, an exemplary use case will now be described with reference to FIG. 7, which is an illustration depicting migration from one datacenter to another with edge locations according to an embodiment. In this example, workload from a first data center D1 is migrating to a second data center D2, wherein the first data center D1 has n edge locations (E1, E2, ... En) each comprising an edge intelligence service.

In this use case, first exemplary algorithm is summarized as follows:
Algorithm 1: Train a distributed neural network to identify suitable edge locations that can be used as source for workload migration.
Input - Batches of workload waves (e.g., container, VM, or serverless) of D1 data center and their corresponding edge locations
Output - A list of source edge locations which are suitable for each wave workload to be migrated with Service Outage Time Objective as a result of the migration to near 0.

Pseudo Code for Algorithm 1:

1 For each batch b in batches of workload
2 For each workload A in b
3 For each edge location i in edges where A is deployed
4 δ_{Ai}, δₜ = Neural ODE solver(DNN, Ai T bc}
5 if δ_{Ai} < th :
6 latest_A = Ai
7 th=δ_{Ai}
8 if δ_{Ai} < tt :
9 busiest_A = Ai
10 tt = δₜ
11 optimizer(grad (loss_fn, δ_{Ai}, δₜ), DNN )
12 rank all edge locations for A based on the business impact
13 L_{A} = top 4 locations from all ranked edge locations
14 Locations.add(L_{A})

In the above algorithm, each workload (A) is considered a multi-variate time series. One workload A can be replicated in multiple edge locations. For each of those locations, workload A can have a different version. Workloads in edge locations are continuously changing. For example, the workloads change while the edge cluster has local cache and is constantly synchronizing with the primary workload.

In embodiments, to compute the changes, boundary condition bc may be considered. For example, the current version at time t for each i-th location is included in the model training. In one example, no workload older than τ is included in the training for the machine learning model. In examples, to cater for significant and continuous changes, a Neural Ordinary differential equation (ODE) solver is employed to determine the changes in workload for small time changes. The Neural ODE solver takes a Distributed Neural Network (DNN) model and trains it with the workload controlled by boundary conditions (bc).

In embodiments, the next step is to determine the suitable edge location(s) that can be used for optimized migration of workload A with the best achievable availability characteristics (e.g., minimal downtime through migration). The busiest version of workload A may have more impact than another replica of A at different edge location. On the other hand, the latest version of A may obtain maximum migration from single point.

In embodiments, the machine learning algorithm seeks to select the most optimum edge location as the source of migration of workload A. For this, each edge location is ranked based on their frequency of changes and access δₜ. From line 5 to line 10 in Algorithm 1 above, the exemplary training method selects the suitable edge location for workload A migration based on latest version of workload A as well as mostly accessed or busiest edge location for A.

So that the proposed learning model may learn the business impact for each edge locations, embodiments may employ a loss function for the gradient of the neural network model. Instead of conventional democratic selection of edge location, embodiments compute the business impact (δₜ) of each edge location. Edge locations with lowest business impact may then be ranked higher as suitable candidates for migration. At the same time, the latest versions of workloads are ranked higher as suitable candidate for migration source location. To balance these two opposite controlling factors, a loss function may be defined which also controls the gradient descents of the proposed distributed neural network model. An exemplary algorithm for this may be summarized as follows:

Algorithm 2 - loss_fn(δ_{Ai}, δₜ)
Input - The changes in workload (δ_{Ai}) and the frequency of access (δₜ) of workload of A at any time t
Output - Changes in business impact as the loss for the gradient of the DNN model

Pseudo Code for Algorithm 2:

1 M1 = Mean Square root {target_imact, pred-imapct X δ_{Ai} X weightU)
2 M1 = Mean Square root {target_imact, pred-imapct X δₜ X weightV)
3 Loss= min(M1,M2)
4 Return Loss

Instead of migrating any workload from a single source node for T time making RTO= T, embodiments may choose multiple locations for workload migration in parallel. By way of example, an exemplary algorithm for parallel migration from multiple edge locations may be summarized as follows:
Algorithm 3: Migrate correlated applications together and in parallel
Input - Batches of wave workload of D1 data center and Locations from algorithm 1
Output - Migration of workload in parallel

Pseudo Code for Algorithm 3:

1 For each batch b in batches of workload
2 For each workload A in b
3 For each edge location 1 for A in Locations
4 While D2(A) != D1(a)
5 Execute migration of A from 1 in parallel

Furthermore, embodiments may also be configured to adapt/improve based on monitoring and/or feedback data. For instance, to verify how well the machine learning algorithm/model performs when suggesting edge locations, the migration metrics may be tracked. This could be monitored either on a per-edge device basis, or throughout all deployments across a network environment. During and/or after migration, the edge device may verify and/or assess the migration by analyzing activity logs.

Collected migration data may be made accessible by an operator or a Site Reliability Engineer, so that manual analysis and/or modifications may be made.

It should now be understood by those of skill in the art, in embodiments of the present invention, the proposed machine-learning concepts provide numerous advantages over conventional workload migration approaches. These advantages may include, but are not limited to:
Migration of correlated applications together and in parallel;
Reduction in service outage;
Assurance of the validity and/or consistency of migrated data; and
Automatic migration execution with reduced cost;
Embodiments may provide multi cloud management (MCMP) concepts for automating datacenter migration in real time. This functionality may be provided as an extension to an existing MCMP system. For example, MCMP, as deployed on an edge layer, has a cloud component to it that may execute the algorithms to undertake the proposed workload migration concepts.

In still further advantages to a technical problem, the systems and processes described herein provide a computer-implemented method for efficient workload management and/or workload migration at edge computing environments. In this case, a computer infrastructure, such as the computer system shown in FIGS. 1 and 4 or the cloud environment shown in FIG. 2 can be provided and one or more systems for performing the processes of the invention can be obtained (e.g., created, purchased, used, modified, etc.) and deployed to the computer infrastructure. To this extent, the deployment of a system can comprise one or more of:
(i) installing program code on a computing device, such as computer system shown in FIG. 1, from a computer-readable medium;
(ii) adding one or more computing devices to the computer infrastructure and more specifically the cloud environment; and
(iii) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of training a machine learning algorithm for identifying an edge computing environment location as a target for workload migration, the method comprising:
receiving: i) a description of a training workload; and ii) an identifier of an edge location for migrating the training workload; and
training the machine learning algorithm based on the description of a training workload as a training input for the machine learning algorithm and the identifier of the edge location for migrating the training workload as a training output for the machine learning algorithm.

2. The method of claim 1, wherein the training comprises adjusting a configuration of the machine learning algorithm so as to decrease an outage time objective.

3. The method of claim 1, wherein the training comprises:
adjusting a configuration of the machine learning algorithm so as to decrease a difference between the identifier of the edge location for migrating the training workload and a second identifier that is output by the machine learning component.

4. The method of claim 1, wherein the machine learning algorithm comprises a neural network and wherein the training is based on a loss function for a gradient of the neural network.

5. The method of claim 1, wherein the description of the training workload comprises a time series of a plurality of variables.

6. A method for workload migration at an edge computing environment, the method comprising:
providing a description of a workload to a machine learning algorithm for identifying an edge computing environment location as a target for workload migration; and
obtaining a prediction result from the machine learning algorithm based on the description of the workload, the prediction result including an identifier of an edge location.

7. The method of claim 6, wherein the machine learning algorithm is trained using a training algorithm configured to receive an array of training inputs and known outputs, wherein the training inputs comprise descriptions of training workloads and the known outputs comprise identifiers of edge locations for migrating the training workloads.

8. The method of claim 6, further comprising communicating the workload to an edge computing environment associated with the identifier of an edge location included in the prediction result.

9. The method of claim 6, further comprising:
prior to providing the description of the workload to the machine learning algorithm, processing the description of the workload so as to meet a predetermined formatting requirement.

10. The method of claim 6, further comprising:
receiving feedback on the prediction result; and
modifying the configuration of the machine learning algorithm based on the received feedback.

11. A computer program product for training a machine learning algorithm for identifying an edge computing environment location as a target for workload migration, the computer program product comprising one or more computer readable storage media having program instructions embodied therewith, the program instructions executable by a processing unit to cause the processing unit to perform a method comprising:
receiving: i) a description of a training workload; and ii) an identifier of an edge location for migrating the training workload; and
training the machine learning algorithm based on the description of a training workload as a training input for the machine learning algorithm and the identifier of the edge location for migrating the training workload as a training output for the machine learning algorithm.

12. The computer program product of claim 11, wherein the training comprises adjusting a configuration of the machine learning algorithm so as to decrease an outage time objective.

13. The computer program product of claim 11, wherein the training comprises:
adjusting a configuration of the machine learning algorithm so as to decrease a difference between the identifier of the edge location for migrating the training workload and a second identifier that is output by the machine learning component.

14. The computer program product of claim 11, wherein the machine learning algorithm comprises a neural network and wherein the training is based on a loss function for a gradient of the neural network.

15. The computer program product of claim 11, wherein the description of the training workload comprises a time series of a plurality of variables.

16. A computer program product for workload migration at an edge computing environment, the computer program product comprising one or more computer readable storage media having program instructions embodied therewith, the program instructions executable by a processing unit to cause the processing unit to:
provide a description of a workload to a machine learning algorithm for identifying an edge computing environment location as a target for workload migration; and
obtain a prediction result from the machine learning algorithm based on the description of the workload, the prediction result including an identifier of an edge location.

17. The computer program product of claim 16, wherein the machine learning algorithm is trained using a training algorithm configured to receive an array of training inputs and known outputs, wherein the training inputs comprise descriptions of training workloads and the known outputs comprise identifiers of edge locations for migrating the training workloads.

18. The computer program product of claim 16, wherein the program instructions are executable to communicate the workload to an edge computing environment associated with the identifier of an edge location included in the prediction result.

19. The computer program product of claim 16, wherein the program instructions are executable to:
prior to providing the description of the workload to the machine learning algorithm, process the description of the workload so as to meet a predetermined formatting requirement.

20. The computer program product of claim 16, wherein the program instructions are executable to:
receive feedback on the prediction result; and
modify the configuration of the machine learning algorithm based on the received feedback.

21. A system for training a machine learning algorithm for identifying an edge computing environment location as a target for workload migration, the system comprising:
a processor arrangement configured to:
receive: i) a description of a training workload; and ii) an identifier of an edge location for migrating the training workload; and
train the machine learning algorithm based on the description of a training workload as a training input for the machine learning algorithm and the identifier of the edge location for migrating the training workload as a training output for the machine learning algorithm.

22. The system of claim 21, wherein the training comprises adjusting a configuration of the machine learning algorithm so as to decrease an outage time objective.

23. The system of claim 21, wherein the training comprises adjusting a configuration of the machine learning algorithm so as to decrease a difference between the identifier of the edge location for migrating the training workload and a second identifier that is output by the machine learning component.

24. The system of claim 21, wherein the machine learning algorithm comprises a neural network and wherein the training is based on a loss function for a gradient of the neural network.

25. The system of claim 21, wherein the description of the training workload comprises a time series of a plurality of variables.
